(19) United States
(12) Patent Application Publication
(10) Pub. No.: US 2005/0226312 A1
(43) Pub. Date: Oct. 13, 2005

(54) Transceiver device

(75) Inventors: Manfred Koslar, Berlin (DE); Zbigniew Ianelli, Berlin (DE); Rainer Holz, Berlin (DE)

Correspondence Address: MERCHANT & GOULD PC, P.O. BOX 2903, MINNEAPOLIS, MN, 55402-0903, US

(73) Assignee: NANOTRON TECHNOLOGIES GMBH, Berlin (DE)

(21) Appl. No.: 10/510,553

(22) PCT Filed: Apr. 8, 2003
(86) PCT No.: PCT/EP03/03617

§ 371 Date: May 16, 2005

(30) Foreign Application Priority Data
Apr. 10, 2002 (DE) 102 15 798.7
Nov. 11, 2002 (DE) 102 52 626.5

(51) Int. Cl. H04B 1/69

(52) U.S. Cl. 375/142; 375/150; 375/219

(57) ABSTRACT

The transceiver according to the invention is a transmitting and receiving device for the transmission of digital signal sequences. Chirp signals are used for signal transmission by way of the air interface, such signals making it possible for the BT-product in the transmission band to be very much greater than the BT-product in the baseband by simultaneous frequency and time spreading. The transmitting and receiving device is distinguished in that chirp signals which are different in respect of the BT-product and/or the time-frequency characteristic can be stored in a memory in order for them to be selectively called up and raised into the transmission frequency band by direct upward conversion. No mirror frequency bands are produced with this procedure so that complicated band pass filters in the carrier frequency position can be eliminated. Direct and automatic demodulation into the baseband is also possible in the receiver, being dependent on the feasibility of the asynchronously operating dispersive filters (for example in the form of SAW components) for the carrier frequency band. As the dispersive SAW filters which can be produced at the present time in the microwave field are still of excessively low efficiency, the invention set forth herein describes receiver structures which presuppose an IF part, in which structures therefore compression of the received chirp signals is effected in the IF position. The compressed chirp signals can then be asynchronously demodulated into the baseband by rectification or, when using convolution pulses, by multiplication. The transmitting and receiving device according to the invention is distinguished by remarkable robustness and resistance in relation to narrow-band and wide-band interference signals. The overall system belongs to the class of matched filter systems.

The invention relates to a transmitting-receiving device, referred to as a transceiver, which is suitable within a transmission system both for producing and emitting and also for receiving and processing chirp signals.

With the transceiver according to the invention chirp signals or combinations of chirp signals of differing configuration are produced and emitted and likewise different chirp signals or combinations of chirp signals are received and processed.

Processes for producing chirp signals are well known from the art. Thus for example in the radar art dispersive delay lines are in the form of surface acoustic wave filters (SAW), such that, after excitation with a signal pulse, they produce a corresponding chirp signal, that is to say a downchirp signal or an upchirp signal.

Generally the transceivers also include suitable receiving devices which receive the upchirp or downchirp signals and in turn subject them to further processing in circuits, wherein a received upchirp can be for example a logic zero and a received downchirp can be a logic one in the sense of digital technology. Once again suitably configured SAW filters serve to receive the chirp signals.

Hitherto, when various chirp signals are to be produced in such a transceiver, a correspondingly large number of SAW components also had to be provided as only one given chirp signal characteristic can be produced per SAW filter. For a change in the chirp characteristic, it is then basically necessary to switch over to the respectively required SAW filter, and wide-band analogue switches are used for that purpose. The desired flexibility is achieved at the cost of a very high level of circuitry expenditure.

In accordance with the presentday state of the art dispersive SAW filters cannot be produced for just any high frequency ranges. Therefore the chirp signals generally have to be produced in the IF-position and then converted with modulation devices into the transmission frequency band. Before emission expensive and complicated measures additionally have to be taken for mirror frequency suppression. The dispersive SAW filters available at the present time in addition have a high level of insertion damping (for example −24 dB), the compensation of which, with suitable wide-band amplifiers, always entails an increased current consumption on the part of the entire system.

A further variant of chirp signal production is tuning a voltage-controlled oscillator (VCO) with a ramp-shaped signal. Depending on the respective characteristic of the VCO a voltage which rises in a ramp configuration at the control input can produce for example an upchirp while a voltage which falls in a ramp configuration can produce a downchirp. That process is in principle very simple and makes it possible for chirp signals to be produced directly in the transmission frequency position. It will be noted however that problems are involved in emitting successive chirp signals of the same characteristic, for example a sequence of upchirp pulses. In that case the control signal has a discontinuity at the transition from one chirp pulse to the other, whereby a switching function is superimposed on the output signal, with the consequence that the spectrum is undesirably increased in width. That means that the chirp signal in the transmission frequency position has to be further subjected to band pass filtering prior to emission, with attendant expenditure and complication.

In general the ramp-shaped voltage signal at the VCO control input also cannot be reset as quickly as may be desired so that the result is a sawtooth-shaped control signal with a long ramp for chip production and a short return ramp. That in turn undesirably produces a further very short chip pulse with its own frequency-time characteristic, which is perceived at the receiver end as noise. Blanking out the short ramp however again produces a switching function with the consequence of spectral broadening of the transmission signal.

A further technically known method which in that respect can be well integrated is the synthetic production of any signals in an intermediate frequency position or in the baseband. In that case sampled signals which are quantized at a higher stage are held in a memory and when required subjected to digital/analogue conversion and converted into the transmission frequency band. This process is advantageous in particular because of the possible flexibility. It can also be readily used for the synthesis of chirp signals. The disadvantage of this method however is that a comparatively high level of complication and expenditure in terms of digital technology and storage space is involved, particularly when, with a high degree of quantization, a relatively large number of chirp signals of differing characteristics have to be provided. That storage requirement and the necessity for higher-stage D/A converters however always also entails an increased level of power demand in the transmitter part of the transceiver and naturally a larger chip area if the situation involves integrating the transmitter functions.

To sum up it can be said that, with the previously known methods, the production of chirp signals of differing characteristics entails a high level of circuitry complication and expenditure (for example due to the provision of a high number of different dispersive SAW filters and the associated analogue switches in the transmitter), a high level of current consumption in the transmitter (for example to compensate for the insertion damping in the dispersive SAW filters), expensive measures for mirror frequency suppression and for spectral shaping in the transmission frequency band or an increased requirement for chip area if complex digital signals such as for example higher-stage D/A converters have to be implemented.

The problem of the invention, for producing, emitting and receiving chirp signals of differing characteristics, is to provide a transceiver, that is to say a transmitter and a receiver, which in terms of the different chirp signals produced is of a simpler structure than the previously known transceivers, which affords the maximum level of flexibility in the choice of the chirp characteristic, which produces chirp signals or combinations of chirp signals in the transmission frequency band without going by way of an intermediate frequency position, and which does not require any spectral shaping and filter measures in the transmission band.

In accordance with the invention that object is attained by a transceiver having the features of claim 1. Advantageous developments are set forth in the appendant claims.

The transceiver according to the invention serves for producing, emitting and receiving chirp pulses. In the special case chirp pulses are linear frequency-modulated pulses of constant amplitude of the duration T, within which the frequency progressively changes linearly between a lower and an upper frequency in a rising mode (upchirp) or falling mode (downchirp). The difference between the upper and lower frequencies represents the band width B of the chirp pulse. The overall duration T of the pulse, multiplied by the band width B of the pulse, is referred to as the expansion or spread factor ψ.

If a chirp pulse passes a dispersive filter of suitable frequency-transit time characteristic then what occurs at the output of that filter is a carrier frequency pulse with a sin(x)/x-shaped envelope curve—what is referred to as a compressed pulse. The peak power of the compressed pulse is then increased in relation to the peak power of the input chirp pulse by the factor B•T. The compression of a chirp pulse is reversible. If a carrier frequency pulse with a sin(x)/x-shaped envelope curve of the band width B passes a dispersive filter of suitable frequency-group transit-time characteristic, then the result is a chirp pulse of equal energy, of the length T. In order therefore to convert a sin(x)/x-pulse into a chirp pulse, firstly it must be impressed on a carrier oscillation and then passed to a dispersive filter. That already describes a current process for producing chirp pulses.

Communication transmission with chirp pulses can be organised in a particularly simple situation in such a way that the symbol alphabet comprises the two elements ‘upchirp’ and ‘downchirp’. For example an upchirp pulse would be transmitted for a logic zero while a downchirp pulse would be correspondingly transmitted for a logic 1.

If the advantage of active transmission of both logic states is waived, then it is also possible to establish on/off keying with upchirp pulses or on/off keying with downchirp pulses.

A special form of the chirp signals or the combination of chirp signals is the convolution signal. It is produced by the simultaneous production and superimposition of an upchirp pulse and a downchirp pulse. By virtue of the choice of a suitable phase displacement between the upchirp and downchirp pulses it is possible for convolution signals to be generated in such a way that, after demodulation at the receiver end, they have a positive or a negative deviation so that active transmission of the two logic states (zero and one) is also possible with convolution pulses.

The aim of the invention is to provide a transmitting-receiving device which at the transmitter end produces and emits chirp signals and which at the receiver end is capable of receiving and demodulating chirp signals. Chirp signals were selected for communication transmission for the reason that they have a series of advantages over other modulation signals:

By conversion into a chirp signal, it is possible to transform a short pulse of high peak power into a chirp pulse of equal energy but which is much longer, in which case the transmission power is correspondingly reduced, for example to the allowed peak power of a power-limited transmission channel. That pulse is transmitted by way of the transmission channel to the receiver and compressed there. In that case once again a short pulse is produced, which is increased in power in relation to the reception pulse. Accordingly therefore, a signal of much higher peak power and therefore with a much greater spacing in relation to noise signals has been transmitted by way of the power-limited channel.

In the reverse way of looking at the situation, a chirp transmission signal can stand out from other transmission systems which transmit at full signal power by way of power-limited channels, insofar as the particular signals are chirped, that is to say transmitted at a greatly reduced level of power, without the performance dropping off in relation to the comparative systems. Chirp transceivers therefore present themselves for use in environments in which a reduction in radiation loading by transmission installations (low human exposure) is an important consideration.

Chirp signals are wide-band signals and they can be produced in such a way that their spectrum completely fills an available transmission channel of the band width B. For that purpose, for a symbol to be transmitted, a carrier frequency pulse with a sin(x)/x-shaped envelope curve is produced and then transformed into a chirp pulse. That carrier frequency pulse is of a mean width □ which is determined as the inverse of the band width B. Accordingly the available channel band width B determines the possible time resolution of a chirp transmission system. When preparing for chirp transmission therefore firstly pulses are produced with the lowest possible BT-product (B•δ=1). Those pulses are converted prior to transmission by way of the air interface into chirp pulses of equal band width B but much greater duration T. In other words, the pulses are transmitted by way of the air interface with a much greater BT product (B>>1). The reverse procedure takes place at the receiver end. The incoming chirp pulses are again converted into sin(x)/x-pulses of the BT-product B•δ=1 and subjected to further processing.

The serious increase in the BT-product prior to transmission by way of the air interface is the real reason why chirp transmission processes are so robust in relation to disturbances in transmission. Other signal transmission processes in which the BT-product remains the same in signal preparation at the transmitter end, during transmission and in signal processing at the receiver end, do not enjoy that advantage.

Data sequences of any symbol rate R up to the limit data rate can be reproduced on chirp pulses and transmitted using the full channel band width. In regard to the situation where the symbol rate is less than the band width B, it is possible to refer to frequence spreading of the symbol sequence to channel band width. Linked thereto is a spreading gain which can be determined as the quotient of the band width B and the symbol rate R.

A matched filter receiver serves to receive chirp signals. Clearly that spreading gain can therefore be so interpreted that the transmitted chirp signal is compressed (that is to say unspread) in the receiver by means of an especially adapted matched filter (the dispersive delay line) while non-chirped signal components, for example superimposed interference or noise signals, are spread in the same matched filter of the receiver.

The possible spread gain reaches a maximum when the symbol duration 1/R is equal to the chirp duration T. It becomes minimum when the symbol rate R is equal to the chirp band width B.

If when chirping a sequence of symbols the symbol duration 1/R is less than the chirp duration T, then each individual symbol experiences a spread in respect of time beyond its symbol limits. A chirp pulse is produced for each symbol, with the chirp pulse being longer than the symbol itself. Then, a sequence of chirp pulses which are superimposed and overlap in respect of time occurs at the output of the dispersive filter.

The spread in respect of time of the symbols can be determined by the quotient of the chirp duration T and the symbol duration 1/R. It reaches its maximum when the symbol rate R and the chirp band width B are the same.

The spread in respect of time of the symbols involves a further transmission advantage which becomes particularly effective at high data rates. The time spread of the symbol to the much greater length T means that the symbol energy of each symbol is distributed along the time axis over a correspondingly greater range.

If disturbances and in particular short-term interferences occur in signal transmission, then it is possible to use the time-spread transmission for interference suppression. It may be assumed that the transmitter emits time-spread symbols (in the example, chirp pulses), wherein superimposed thereon on the transmission path are wide-band interference pulses (for example quasi-Diracime pulses). The signal mixture of chirp pulses and interference pulses passes at the receiver input a dispersive filter (chirp filter) which implements compression of the chirp pulses into sin(x)/x-pulses. All non-correlated signal components, that is to say which are not present in the form of chirp pulses, are in that situation spread in respect of time. Their interference energy is distributed over a greater period of time, that is to say over a plurality of adjacent symbols. The probability that an individual symbol is destroyed by such an interference pulse is reduced. The bit error rate in transmission also falls at the same time.

In summary it can be said that chirp signals for data transmission over wide-band and interference-affected communication channels afford a series of advantages which predestine them for use in the transceiver according to the invention.

A technically well-known variant of the synthesis of transmission signals which is wide-spread for example in software radio systems is the digital production of signals in an intermediate frequency position. That process also presents itself for the representation of chirp signals.

In that case the sampled and quantized chirp signal is stored in a memory, for example an ROM, in the IF-position. To produce a chirp pulse the stored chirp sequence is passed to a digital/analogue converter, at the output of which the analogue chirp signal can be taken off. By virtue of the high sampling rates necessary that method can only be considered for the lower frequency positions (low IF). Conversion into common transmission frequency positions, for example in the ISM band, always still requires suitable upward mixers and associated filter measures for mirror frequency suppression. In accordance with the stated object of the invention however, for reasons of simplicity, the aim is to forego spectral filtration procedures, mirror frequency suppression and band restriction in the transmission frequency band. In addition the aim is to provide for the simplest possible structure for the transmission device and the maximum level of flexibility in terms of selecting the transmission signals.

In accordance with the invention therefore the storage of the complex chirp signal in the baseband offers a better way. For that purpose the real part and the imaginary part of the provided chirp baseband signal are sampled, quantized and stored as independent bit sequences in the memory (for example an RAM or an ROM). In the baseband part of the transceiver the stored baseband sequences can be read out upon being fetched and can be converted into a chirp signal in a transmission frequency position.

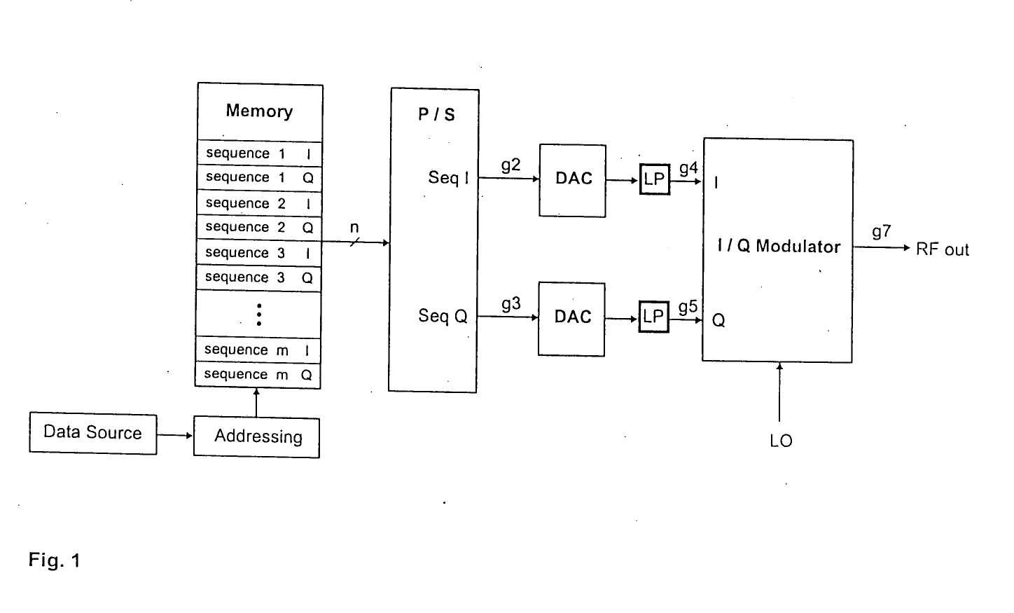

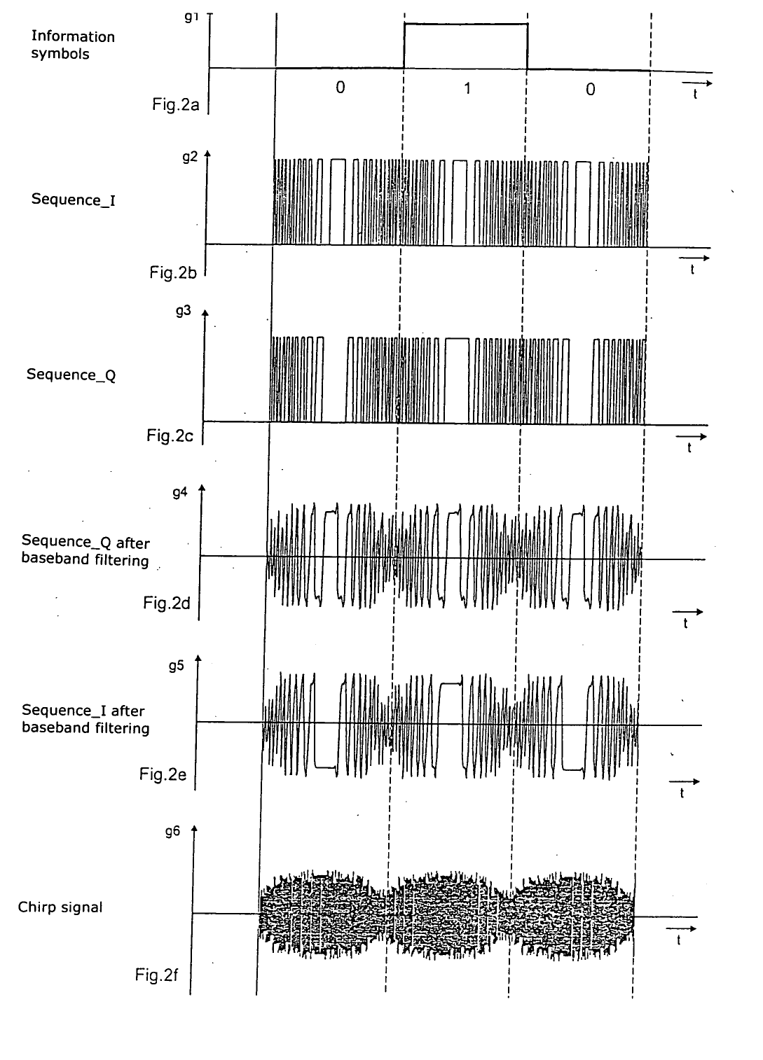

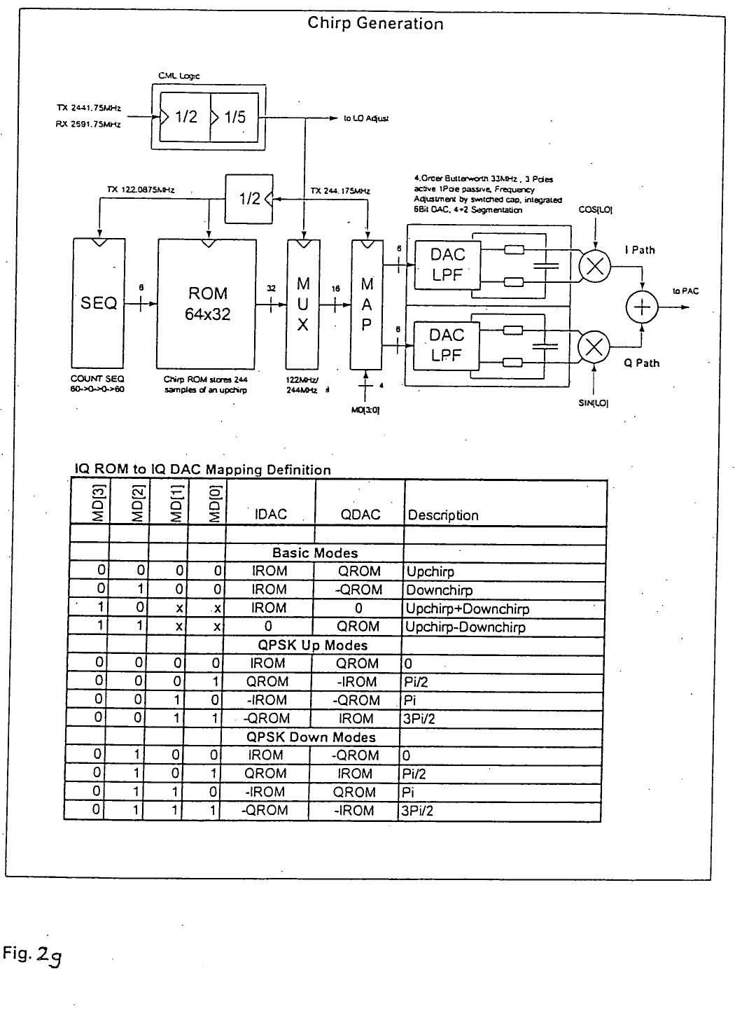

FIG. 1 illustrates a transmission device by way of example. FIG. 2 shows the signals occurring at the various points in the arrangement.

Different chirp baseband signals are separately stored in accordance with the real part and the imaginary part in a memory (see FIG. 1) as bit sequences (sequence 1, sequence 2, . . . ). The selected chirp sequence pair in question is addressed by way of the block ‘Addressing’ which is connected for example to a digital data source. FIG. 2a shows by way of example three information symbols (LOW; HIGH; LOW) of a digital data source, which are to be transmitted.

For each of those symbols, two bit sequences (sequence_I and sequence_Q) are read out by way of the block ‘Addressing’ (FIG. 1), by way of a reading-out device, for example a parallel/series converter. At the output of the parallel/series converter are the two bit sequences g2 and g3 (see FIGS. 2b and 2c) which are passed to the inputs of digital/analogue converters (DAC). The D/A-converted signals are filtered with the two low pass filters (TP) in the baseband. The signals g4 and g5 occurring at the output of the low pass filters (see FIGS. 2d and 2e) are transferred by means of a suitable modulation device (for example an I/Q-modulator) directly into the desired transmission band. The chirp signal g6 (see FIG. 2f) at the output of the I/Q-modulator does not contain any mirror frequencies so that it can be emitted in the transmission frequency position without further filter measures.

It is a particular advantage of this process that chirp signals of any characteristic (for example upchirps, downchirps or chirp signals with a differing BT-product and a differing characteristic) can be stored in the memory, and with sufficient memory space they can be selectively fetched so that, depending on the requirements involved in transmission, it is possible to have recourse to one of the stored chirp signals or the other. It can also be envisaged that the required chirp sequences, in the procedure involved in starting operation or initialising, are transferred into the memory by way of a download, but if required can also be replaced by re-programming. Accordingly the transceiver has a programmable transmission part which makes it possible to select the transmission signals with the highest possible level of flexibility and to emit them without changes to the hardware (see FIG. 1).

Some parameters are necessary for digital storage of a chirp signal, not least for estimating the memory requirement. They include initially the sample rate (chirp sample rate). It is dependent on the band width of the chirp signal, its minimum value is determined by the sampling theorem.

There is a greater degree of freedom in regard to establishing quantization. It can be shown that, with an arrangement as illustrated in FIG. 1, it is readily possible to produce chirp signals if the selected quantization of the pre-stored sequences has an only very low number of stages.

The proposed process makes it possible for bit quantization to be freely selected in the range of 1, 2, 3 . . . n bits. In other words, in the simplest case of 1 bit quantization frequencies of the digital symbols ‘0’ and ‘1’ are sufficient, for representation of a chirp signal in the baseband. In that particular case the connected circuit is further simplified by virtue of the digital/analogue converters becoming superfluous. As a distinction from known processes for signal synthesis in the baseband, the transceiver according to the invention (as shown in FIG. 1) can synthesize the transmission signal from two stored binary sequences without additional digital/analogue converters.

In all other cases digital/analogue converters of the appropriate order are employed.

In a particular implementation of the invention convolution signals are used for transmission purposes. For the production of convolution signals upchirp and downchirp signals are superimposed in a given manner in such a way that the resulting signal is purely real. Therefore only a real part has to be stored in the baseband. Thus, for direct modulation purposes, D/A-conversion in only one channel is sufficient, with a simple modulation device (for example a mixer or a modulator) with a real carrier signal. This means that the complication and expenditure for storage of the signals and for the modulation thereof into the transmission frequency band is halved.

As shown in FIG. 1 the two D/A-converters (DAC) are followed by suitable low pass filters (LP), the function of which is to limit the spectrum in the baseband to the desired band width. In the case of 1 bit quantization spectral limitation must be effected solely by those low pass filters, optionally higher-grade filters have to be used.

With higher levels of quantization the sampled and quantized baseband signals can already be weighted prior to storage in the memory with selectable filter functions (for example with a cosine roll-off characteristic) so that the chirp frequencies which are fetched in the transmission situation already satisfy simple requirements in terms of spectral purity of the baseband signals. That reduces the level of the demands on the downstream-connected low pass filters. It can also be envisaged that this baseband pre-filtering already completely satisfies the spectral demands on the chirp signal so that further filter stages are no longer necessary. If it is assumed that a higher-stage level of quantization is specifically selected for that purpose in order to implement additional baseband filtering of that kind, it is then possible to talk of exchanging quantization complication and expenditure (memory requirement, expenditure for digital part and A/D-converter), for the complication and expenditure for implementation of the low pass filter stages.

An embodiment by way of example for the described production of chirp signals is shown in FIG. 2g.

The embodiment of FIG. 2g describes the production of chirp signals of varying characteristic in the ISM band at 2.44 GHz and with a symbol duration of 1 μs.

In a frequency divider firstly the carrier frequency TX 2441.75 MHz is divided down to 244.175 MHz by way of a two-stage frequency divider with the factor 10:1. The frequency produced in that way corresponds to the sample rate with which the chirp signals are to be synthesized in the baseband. Accordingly 244 samples have to be coded within the symbol duration of 1 μs. As the read-out speed of conventional memories (RAM/ROM) is generally too low for them to be read out at that rate, a memory is used, which is operated at half the sample rate, but which in return has double the data bus width. Therefore the frequency TX 244.175 MHz is divided down once again by the factor of 2 to 122.0875 MHz. The sequencer (SEQ) and the memory are operated with that clock. The necessary address space of the memory is determined as a quarter of the length of the chirp sample rate. The data bus width can be determined as the product of the number of quantization stages (in bits) and the factor of 4. The sequences IROM and QROM are stored in the memory.

As the chirp sequence is center-symmetrical, only half of the sequence is stored. In the reading-out operation the complete sequence is produced by counting up the address value and then counting down in the sequencer (SEQ).

The multiplexer (MUX) which is connected to the memory component serialises the data words which are placed in mutually juxtaposed relationship in the memory. The databus from the memory component is multiplexed to a databus which is of half such a width. In that case the data rate of the bit sequences which are read out of the memory is doubled.

For the production of upchirp, downchirp and convolution pulses or symbols in the upchirp QPSK mode or in the downchirp QPSK mode the incoming IROM and QROM data streams are logically linked in the adjoining block MAP (see the Table), thus giving the desired symbols. The selection of symbols is effected by way of a 4-bit data word MD. Accordingly, with only two pre-stored bit sequences, it is possible to synthesize all specified symbols of the various chirp modes of operation.

The two bit sequences for I and Q are converted into analogue signals by means of two D/A converters and subjected to band restriction with the connected low pass filters (in the example leapfrog filters). The output signals of the low pass filters are then converted into the transmission frequency band with an I/Q-modulator.

The chirp transmission system which is subject-matter of this invention basically permits direct compression and demodulation of the incoming chirp signals into the baseband on the receiver side. As however the implementation of suitable dispersive filters for the transmission frequency bands which are common nowadays also encounters considerable technical difficulties, in the present invention each of the illustrated receiver variants is provided with an input stage for conversion of the reception signal into the intermediate frequency position. If dispersive filters can also be embodied in the foreseeable future in the desired higher carrier frequency positions, then the IF-stage can be correspondingly omitted without the rest of the receiver structures according to the invention being affected thereby.

For processing incoming chirp signals the transceiver according to the invention firstly includes at the receiver end a conversion device (mixer, downconverter) which converts the incoming signals into the intermediate frequency position. The intermediate frequency signal is then passed to the inputs of two complementary dispersive delay lines which must be matched in terms of their frequency-group transit time characteristic to the chirp signal characteristic of the transmitter. The compressed pulses which occur at the outputs of the dispersive filters are demodulated with suitable detector circuits into the baseband, there converted with threshold value comparators into data pulses which can be processed in the adjoining digital evaluation circuits of the receiver.

While the characteristic of the chirp signals which are produced at the transmitter end can be easily programmed and also changed, the receiving device is dependent on the use of dispersive filters (for example SAW filters), that is to say the provision of various hardware components. As however, with the exception of the dispersive filters, all the receiver hardware remains unchanged, the receiver can also be easily tuned to a newly selected transmission chirp signal, for example upon adjustment or in service procedures. If for example the dispersive filters are pluggably connected to the receiving device and can be easily exchanged, it is then possible for good reason to also talk of hardware programming of the receiver part.

The transmitting device and the receiving device of the transceiver according to the invention can therefore be conveniently programmed for the transmission of chirp signals of selectable chirp characteristics.

One of the operating modes of the described transceiver is data transmission by means of convolution pulses. The particular advantage of this mode of operation is the small amount of memory required for storing the chirp sequences and the simple hardware structure of the transmitting part.

A convolution pulse is produced by the superimposition of an upchirp pulse and a downchirp pulse which is produced at the same time. Convolution signals can be so generated by the choice of a suitable phase displacement between the upchirp and downchirp pulses that the carrier frequency pulses which occur after compression at the receiver end in complementary dispersive filters admittedly always involve the same envelope curve, but in the case of the ‘positive’ convolution pulses they have the same carrier phase and in the case of the ‘negative’ convolution pulses they have a phase displacement of 180°.

Convolution pulses are particularly easy to demodulate in the receiver. In principle there is the possibility of implementing direct demodulation from the transmission frequency band into the baseband. In that case upchirp and downchirp components can be separated again by complementary dispersive filters with a suitable frequency/transit time characteristic. A compressed upchirp pulse occurs at the output of the one delay line while a compressed downchirp pulse occurs at the output of the complementary delay line. Coherent demodulation into the baseband is achieved by simple multiplication of the two compressed signals. The pulse shape corresponds to a squared sin(x)/x pulse, with positive deflection in the case of a transmitted positive convolution pulse and with negative deflection in the case of a negative convolution pulse.

It will be noted however that the described direct demodulation of convolution signals into the baseband presupposes the presence of dispersive filters for operation in the transmission frequency position (for example in the ISM band around 2.4 GHz). As long as those filters still cannot be produced or can be produced only at disproportionately high cost demodulation can be effected only after converting the reception signal into the IF-position.

The prerequisite for successful demodulation of the convolution pulses in the receiver is the best possible congruence of the envelope curves of the compressed pulses in the receiver.

That congruence can occur only when the center frequency of the received signal which is mixed down into the IF-position coincides as well as possible with the center frequency of the two complementary dispersive delay lines.

In the case of conventional quartz stabilisation of transmitting and receiving LO however such a high frequency displacement can already occur that the demodulation of convolution pulses becomes an impossibility. Because of the complementary frequency-group transit time characteristic of the delay lines the envelope curves of the two compressed pulses then move away from each other on the time axis.

That therefore entails the necessity for carrier recovery from the received chirp signal. As demodulation of the convolution signals occurs not in the baseband but in the IF-position, a local oscillator must be produced, the frequency of which is the difference of the recovered carrier frequency and the known center frequency of the delay lines (that is to say the intermediate frequency used).

As in the received chirp signal the carrier frequency (center frequency) is only one of many frequency components and is in no way distinguished in relation to the others, only methods which can extract the carrier from a pure double-side band signal fall to be considered for carrier recovery.

In this connection the literature [K D Kammeyer: Nachrichtenübertragung pages 424-428, 2nd Edition 1996, Teubner Stuttgart] discloses principles which are based on frequency multiplication of phase-modulated reception signals. Taking the resulting frequency mixture the n-times carrier frequency can then be subjected to narrow-band filtering out and can be divided down and the desired reference carrier is produced by means of a phase regulating circuit. What is common to those processes is that, depending on the state number n of phase modulation the reception signal must be squared (Id n)-times in order to derive the n-times carrier frequency.

The disadvantage of these methods is that multiple product formation of the reception signal can only be implemented at a very high level of technical complication and expenditure, and in the case of common transmission bands (for example the ISM band) the frequencies which are produced in that case rapidly attain such a level that processing (for example dividing down) in phase regulating circuits can only be implemented with difficulty. In addition there is another important reason against the use of those processes. It is not possible to specify a limited number of phase states for chirp signals, and squaring of the reception signal therefore must theoretically take place infinitely often in order to arrive at an evaluatable carrier frequency.

A further technically common method of carrier recovery is use of a Costas regulating loop. Carrier regulation with the Costas loop is based on the received signal being converted into the baseband by means of an I/Q-demodulator, the demodulator output signals being subjected to low pass filtering and then being multiplied together in order in that way to obtain a regulating criterion for the phase of the reference carrier. The VCO which produces the reference frequency can be actuated directly with the product signal.

That process is not suitable for carrier regulation in chirp transmission systems as the demodulated signals in the baseband are not constant but chirped signals, with a completely different phase configuration, so that it is not possible to draw any conclusions about the phase of the reference carrier, from a phase comparison.

The previously known carrier recovery processes are evidently unsuitable for use in the transmission of convolution signals.

What is involved is finding a process which can be applied to chirp transmission processes and which produces and stabilises a local oscillator in such a way that convolution pulses can be received and reliably demodulated.

That requirement is met by an arrangement as set forth in claim 20.

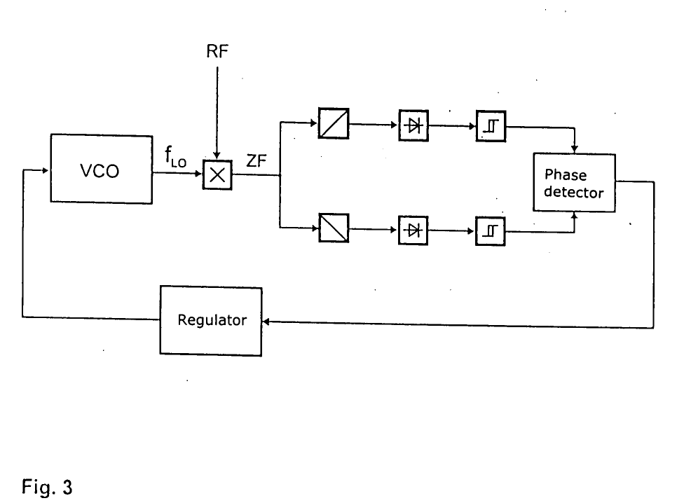

That arrangement is illustrated by way of example in FIG. 3.

This involves a receiving device which firstly converts the incoming RF reception signal into a suitable IF position with a conversion device, for example a mixer, and then feeds it to the inputs of dispersive delay lines with a complementary frequency-group transit time characteristic. The output signals of the delay lines are demodulated into the baseband with detector stages and then converted into rectangular pulses with threshold value comparators. Those rectangular pulses are passed to a phase detector which is followed by a regulator. The output signal thereof influences a voltage-controlled oscillator (VCO) with which the local oscillator (LO) of the system is produced.

If convolution pulses occur at the receiver input, then compressed chirp pulses are produced at the outputs of the complementary delay lines, the time displacement of the chirp pulses representing a measurement in respect of the deviation of the IF center frequency from the center frequency of the delay lines, and which can be used as a regulating criterion for the frequency of the reference carrier (LO).

The phase detector checks for congruence of the demodulated compressed pulses, its output voltage varies in respect of magnitude and polarity depending on the respective established time displacement of the pulses. The subsequent regulator changes the setting voltage of the VCO until the envelope curves of the compressed chirp pulses lie one above the other. The regulating circuit is latched and the prerequisite for multiplicative demodulation of the convolution signals applies.

Accordingly frequency synchronisation does not take place as is usual in the known processes between the carrier frequency of the reception signal and the reference carrier (LO), but between the IF signal and the characteristic of the dispersive filters. The system is not synchronised to a received carrier signal but conversely it synchronises the received signal to a system-specific reference, the center frequency of the complementary dispersive group transit time filters.

The incoming signal is shifted in frequency into the IF position to such an extent until its center frequency and the center frequency of the dispersive filters lie one above the other. In other words, in a simple fashion, the system also regulates out changes in the filter center frequency due to a rise in temperature, ageing or other influences.

In order to synchronise the receiver device, a data sequence can be preceded by a preamble of convolution pulses which serves specifically for bringing the frequency regulating circuit into effect. The synchronisation attained is maintained even upon the subsequent transmission of the data pulses, in that respect it is immaterial whether positive or negative convolution pulses or prolonged sequences of the same polarity are received. If convolution pulses occurring in burst-wise manner are received with the illustrated receiver arrangement, then a preamble must again precede each data burst, for synchronisation purposes.

In a specific configuration of the invention a preamble of convolution pulses is firstly transmitted prior to the transmission of a data burst, and upon the attainment of the latched state the VCO setting voltage is sampled with a sample-and-hold member and held fast for the duration of the data burst.

The structure of the receiver device (see FIG. 3) permits both the reception of convolution signals and also the reception of simple chirp signals (for example upchirp/downchirp). The described regulating circuit can be switched off for the latter case. It is then sufficient to use a simple PLL circuit with a quartz reference for producing the local oscillator.

In a further implementation of the invention a data sequence which comprises upchirp pulses (logic HIGH) and downchirp pulses (logic LOW) is preceded by a preamble of convolution pulses which serves for frequency synchronisation, after latching of the frequency regulating circuit the VCO setting voltage is sampled and held fast for the duration of the data burst. In that case there is no need to provide any additional quartz-stabilised PLL circuit for producing the local oscillator, for the reception of simple chirp signals.

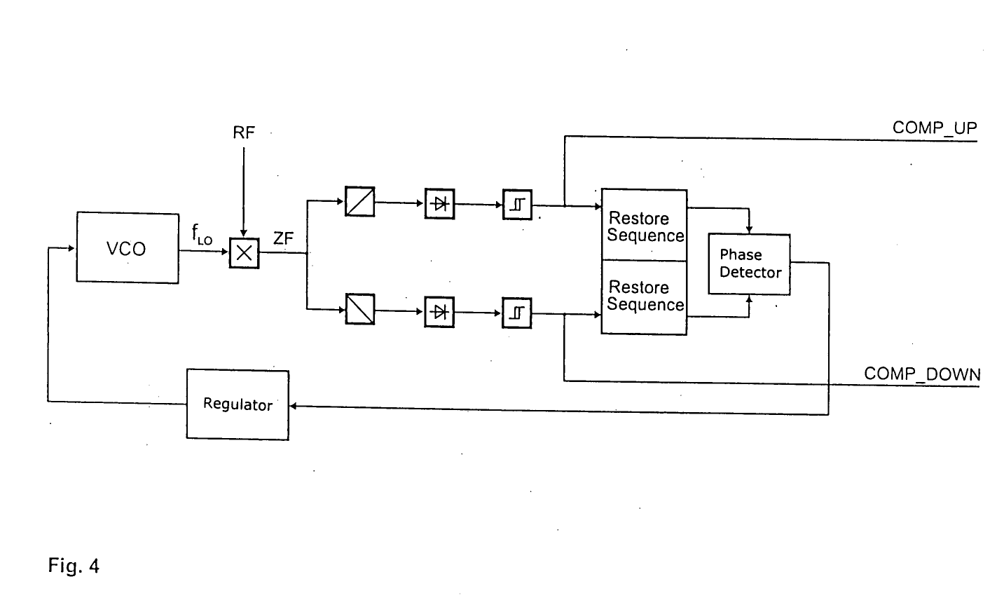

A further implementation of the invention is automatic frequency regulation for an upchirp/downchirp-transmission system, shown by way of example in FIG. 4. In this case, in a preamble, a series of mutually alternate upchirp and downchirp pulses are transmitted. Rectangular pulses then appear in the symbol clock at the inputs of the phase detector, those rectangular pulses being displaced in respect of time from one input to another. In the steady-state condition, that is to say when synchronisation has been achieved, that displacement is precisely half a symbol period, that is to say 180°. For that situation the phase detector is so designed that its output signal in terms of magnitude and polarity reflects the instantaneous phase shift and accordingly disappears in the latched condition. The frequency regulating circuit shown in FIG. 4 can then also be used for frequency regulation of up/down chirp systems. Initially that only applies for the preceding preamble. For the duration of the subsequent data sequence the VCO input signal must be clamped again at the voltage value of the latched condition.

For transmission systems which are used selectively for the transmission of up/down chirp signals or convolution signals, the phase detector can then be adapted to be switchable so that both transmission modes can operate with the same frequency regulating circuit.

The described frequency regulation can only be used for up/down chirp transmission systems if upchirp and downchirp symbols are received alternately at least until latching occurs, for example within a preamble which precedes the data burst. The subsequent data signal is generally characterised by the irregular succession of upchirp signals (for example logic HIGH) and downchirp signals (in the example correspondingly being logic LOW). That also includes prolonged pulse sequences of the same polarity.

In the case of a known symbol period however it is possible for the missing symbols to be inserted as dummy symbols in two branches between two symbols of the same polarity which are displaced in respect of time by more than one period. In FIG. 4 for that purpose a block ‘Restore Sequence’ precedes the phase detector. The uninterrupted symbol sequences which are thus produced in both branches are then fed to the phase detector, the rest of the regulating circuit operates in the known manner. The prerequisite for this process is that the time spacings of similar symbols do not turn out to be too high. In order to ensure this, the symbol sequences can be suitably scrambled in the transmitter prior to the transmission, with the aim of the number of successive symbols of the same polarity not exceeding a fixed value k.

If the up/down chirp transmission system has a receiver as shown in FIG. 4, then frequency synchronisation which is achieved within a preamble can also be maintained during the subsequent transmission of data sequences of any length.

The transmission of digital data sequences presupposes on the receiver end not only frequency synchronisation but generally also clock synchronisation. That involves deriving the symbol clock from the reception signal in correct phase and frequency relationship. Technically common processes are clock derivation with synchronous demodulator for frequency-modulated signals or clock recovery from the demodulated baseband signals, in which the baseband signals which have been subjected to low pass filtering are summed and then the clock frequency is filtered out of the sum signal with a band pass filter. Still other processes provide a specific PLL circuit for clock recovery.

What is common to those processes is that they can only be embodied at a relatively high level of circuitry complication and expenditure. For an integrated transceiver circuit, the functionality of which is to be ensured with the lowest possible power consumption and the smallest possible requirement in terms of chip area, such complicated structures cannot be considered for clock recovery. The task was that of finding a solution for clock derivation, which is founded on the existing structures for chirp signal reception, which arises functionally directly out of chirp signal demodulation and which permits secure reconstruction of the system clock at minimal additional complication and expenditure.

That object is attained by a transceiver as set forth in claim 32.

It is possible with the transceiver according to the invention to send data sequences comprising upchirp/downchirp pulses or data sequences of convolution pulses and to asynchronously demodulate same at the receiver end.

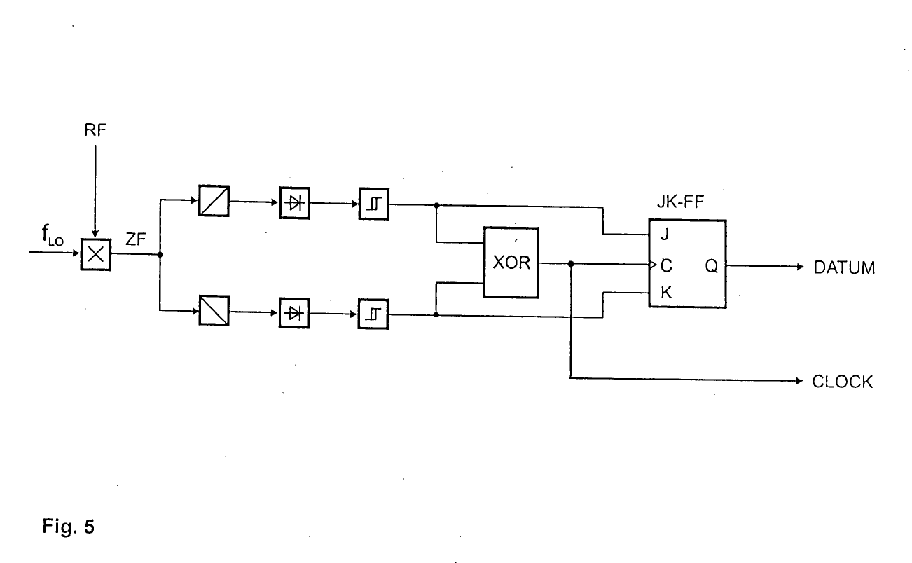

FIG. 5 represents a receiver device for up/down chirp transmission with subsequent clock derivation.

The chirp signals which come in at the receiver input are firstly converted into the IF position, automatically and asynchronously compressed with complementary dispersive delay lines and demodulated into the baseband with detector circuits.

The rectangular pulses which occur at the outputs of the subsequent threshold value comparators only still have to be linked together by a suitable logic member (for example an EXCLUSIVE OR gate) in order to derive the symbol clock. The symbol clock (CLOCK) is fed to the clock input of a jK flip-flop, the inputs j and K are suitably connected to the comparator outputs. In that way the output Q (DATUM) of the flip-flop is set with each clock pulse to the current logic state (for example upchirp=LOW and downchirp=HIGH), for the duration of a period.

The particular advantage of the illustrated process for asynchronously deriving the symbol clock is that the receiver device directly follows every change, at the transmitter end, in the symbol rate and thus the symbol clock without special switching-over procedures or re-initialisation procedures being required in the receiver. This for the first time permits a flexible and a fluid variation in the data rate of a transmission system.

In the situation involving the transmission of convolution pulses the symbol clock, presupposing that frequency regulation is in the steady-state condition, can in principle be derived in the same manner.

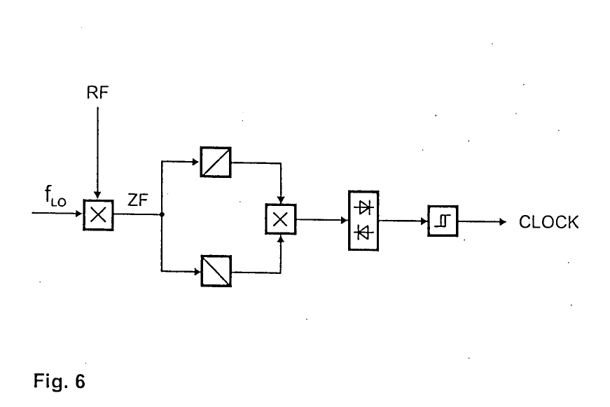

FIG. 6 shows a receiving device for convolution pulse transmission.

The input circuit of the receiving device again comprises a converter and the two dispersive filters. For demodulation of the convolution pulses themselves, the output signals of the two delay lines are directly multiplied by each other, resulting in a bipolar baseband signal. A variant for deriving the symbol clock is full-wave rectification of that baseband signal and subsequent evaluation with a threshold value comparator. The output signal thereof also carries the symbol clock (CLOCK).

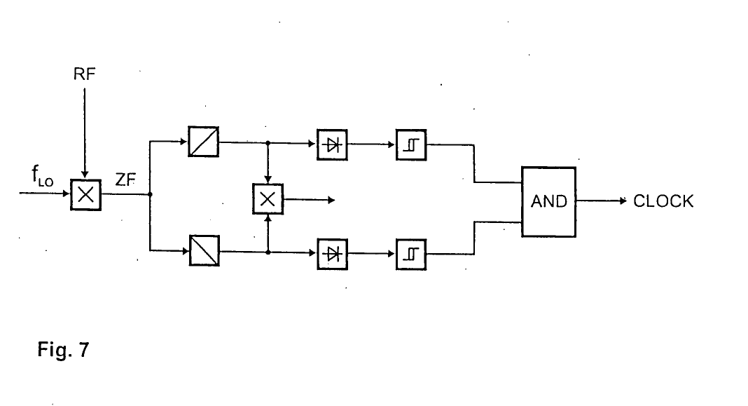

A further variant for clock derivation in respect of convolution pulses is shown in FIG. 7.

This circuit makes use of the fact that, upon the reception of convolution pulses and in the steady-state condition of frequency regulation, the comparator output signals in the two branches equally carry the symbol clock so that, in regard to clock derivation, it is possible to restrict the system to one of the branches. In order to increase security in terms of interference, it is advantageous for the two comparator output signals to be linked by way of a logic AND member. The system clock (CLOCK) occurs at the output of that AND member.

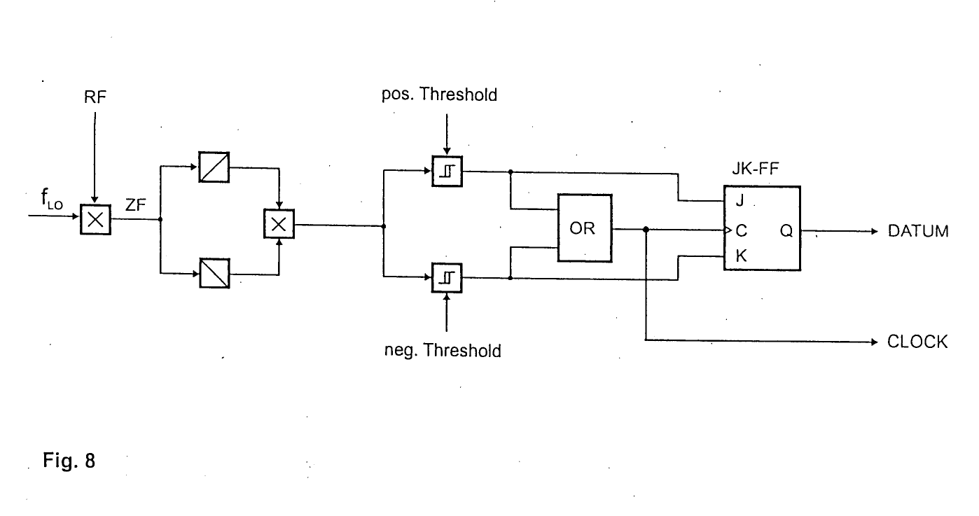

A further variant for clock derivation in respect of convolution pulses is shown in FIG. 8.

FIG. 8 firstly shows the input circuit for the demodulation of convolution pulses (mixer, dispersive filters, multiplier). The prerequisite for clock derivation in the illustrated receiving device is the steady-state condition of frequency regulation.

For demodulation of the convolution pulses themselves the output signals of both delay lines are directly multiplied by each other, this giving a bipolar baseband signal. That signal is compared at two threshold value comparators to a respective positive and a negative threshold value. The output signals of the comparators are linked together by way of a logic OR member in order to derive the system clock (CLOCK). The current datum can be suitably taken off at the output Q of the jK flip-flop.

The transceiver according to the invention makes it possible to implement gating of the comparator output signals at the receiver end in both modes of operation. That gating is directed to the operating situation with a symbol rate which is fixed or which is known to the receiver. The arrangement is further assumed to involve a circuit portion for clock derivation.

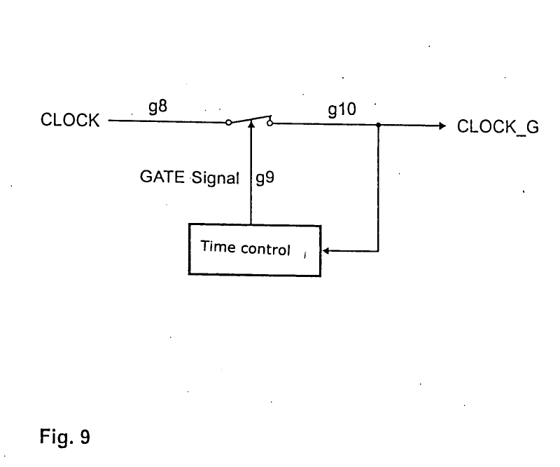

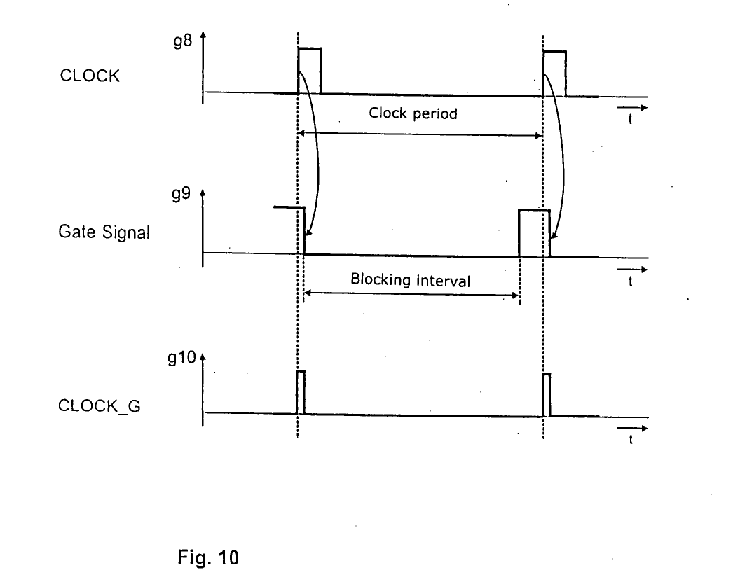

FIG. 9 shows a variant of the gating, which is used in the transceiver. FIG. 10 shows the associated signals, by way of example.

FIG. 9 is a diagrammatic view which firstly shows a switch which is actuated by way of the block ‘Time control’. The CLOCK signal g8 has been produced in an upstream stage for clock derivation. The switch is opened and closed with the signal g9. As shown in FIG. 10 the switch is initially closed in the rest position. The first incoming symbol clock pulse is recognised by the time control and, after a short time delay (controlled by way of the signal g9), triggers opening of the switch and thus the blocking of further pulses which are within a given interval which is less than a symbol period. After the end of the blocking interval the switch is closed again. The next (expected) symbol clock pulse can pass and again triggers off the blocking effect.

The advantage of this arrangement is that interference pulses which occur within a symbol interval are suppressed. That variant is particularly suitable for initial oscillation of the signal. If an interference pulse undesirably first triggers off the blocking effect for example after activation of the system, then the gate is already opened again after a time which is shorter than a clock period. The system does not remain in the blocked condition and can already process the arriving symbol clock pulse.

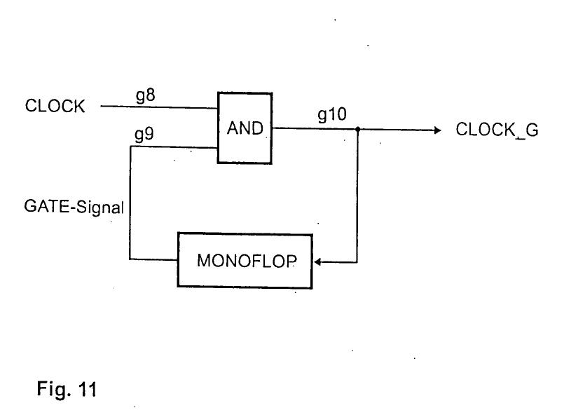

FIG. 11 shows an embodiment of this arrangement.

In this case a logic AND member takes over the function of the switch and a monoflop determines the length of the blocking interval.

A particular implementation of the gating according to the invention provides for using a blocking interval of variable length. The blocking interval can be particularly short for example in the phase involving producing a transient response on the part of the receiving device, while in the steady-state condition the arrangement can be switched over to a longer blocking interval which in the extreme case is only a little shorter than the symbol duration itself.

A further implementation provides that a symbol clock pulse closes the gate for the duration of a blocking interval, and then opens it for the duration of an opening interval (within which the next symbol clock pulse is expected) and then closes it again for the duration of a blocking interval—a procedure which is continuously repeated. That variant is suitable for operation in the steady-state condition.

When a chirp pulse is received by the receiving device of the transceiver, converted into the IF position and fed to complementary dispersive filters, then not only does a compressed pulse occur at the output of one of the two filters, but in addition an expanded chirp pulse also occurs at the respective complementary chirp filter. The expanded chirp pulses appear in each of the two branches as system-specific interference signals which have to be taken into account in terms of detection and subsequent discrimination. After demodulation into the baseband the detected signals are compared to a threshold value in each path. The described effect requires that the threshold value of the comparator is always in the region between the peak values of the expanded pulse and the compressed pulse. That already limits the dynamics of signal detection. In addition the receiving system should also be capable of reacting to changes in power at the detector input. Those changes in power involve the expanded and the compressed signal equally and result in fluctuations in amplitude of the detected signal. If operation is effected with a fixed threshold value, then the detection limits are very rapidly encountered when the amplitude of the incoming signals changes.

That therefore involved finding a device for determining the threshold values, which on the one hand is tuned to the characteristics of chirp signal reception but which on the other hand can also react to changes in power of the input signal.

According to the invention that object is attained by an arrangement as set forth in claim 41.

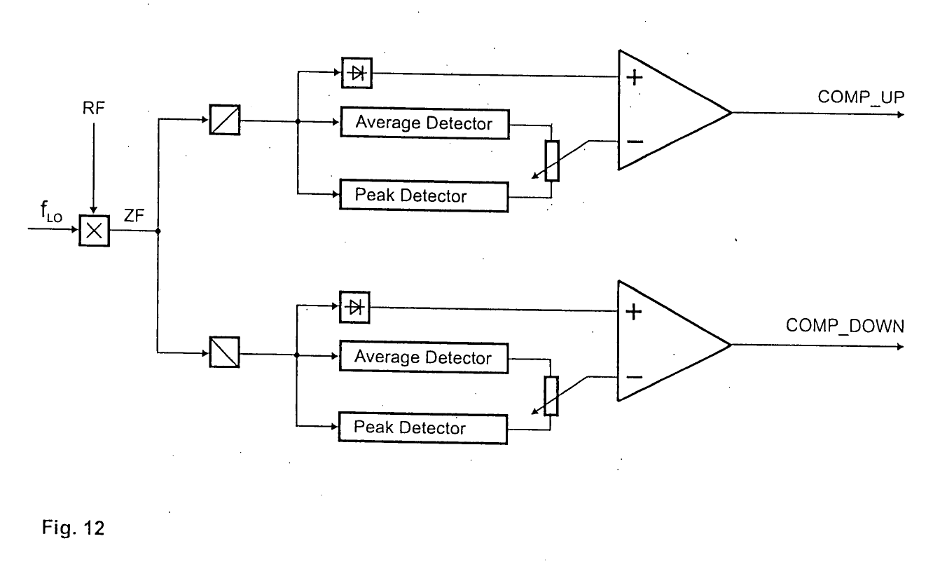

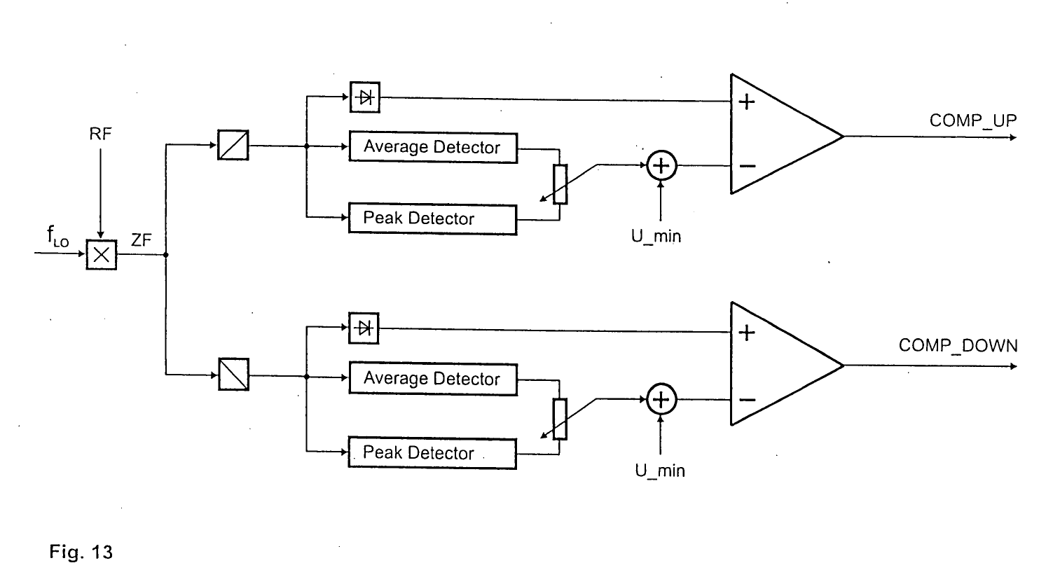

FIG. 12 shows a receiving device according to the invention.

The incoming reception signal is firstly converted into the IF position and passed to the inputs of two complementary dispersive filters. The compressed chirp pulses at the output of each of the two filters are passed in both branches to an envelope curve detector, an average detector and a peak detector. A threshold value for the subsequent comparator is derived from the output signals of the average detector and the peak detector. The threshold value can variably assume any value between the peak value and the average value of the detected signal. In a particular configuration of the invention the position of the threshold value is digitally controllable, within that interval. The output signals of the envelope curve detectors are compared to the threshold values produced in that way in both branches. The signals COMP_UP and COMP_DOWN are ready for digital further processing at the outputs of the two comparators.

In the situation where no reception signals occur the threshold value comparator must afford the highest possible level of sensitivity but the background noise of the receiver device may not result in switching of the comparator. Therefore in a particular configuration of the invention the lower limit of the threshold value is so established that the threshold value, in the rest condition (in the condition of readiness for reception), is always higher than the detection signal of the background noise of the receiver device. For that purpose a voltage U_min is added to the threshold value formed from the average value and the peak value in both branches, thereby providing that the threshold value at the comparator input is always higher than the noise amplitude at the detector output.

In summary it can be said that the transceiver with the combination according to the invention of detector and comparator with adaptive threshold establishes the threshold values in respect of amplitude discrimination in such a way that, even in the event of power changes in the signal at the detector input, reliable detection of complementary chirp signals is possible.

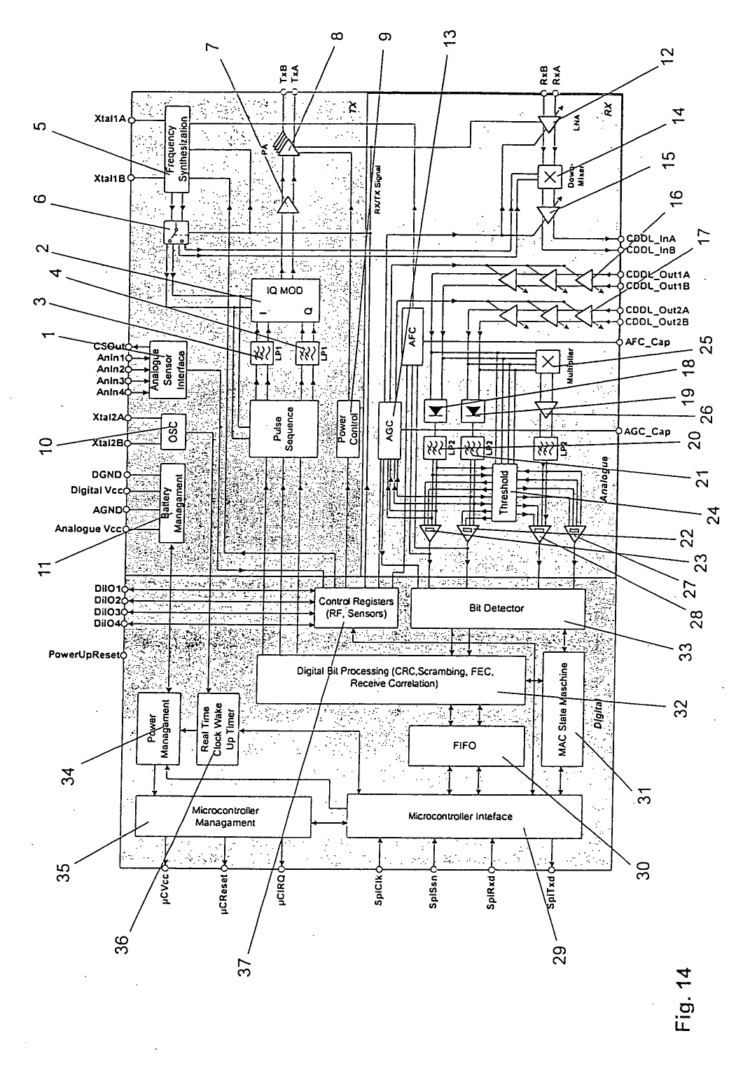

The NANONET-transceiver, the block circuit diagram of which is shown in FIG. 14, is represented in the variant which is advantageous here as a highly integrated circuit which is provided for the transmission of digital data sequences and which in a very small space includes a complete transmitter (from the digital input to the RF power amplifier), a complete analogue receiver (from the antenna input to the output for the demodulated and digitised reception data), a programmable analogue control device and a programmable digital control device.

The analogue control device comprises power management, analogue/digital converters, current sources, battery charge monitoring, alarm signalling and other components. All essential functions of that functional block can be initialised and controlled by the application software.

The programmable digital control device which communicates with external microcontrollers by way of a serial periphery interface (SPI) provides various control functions for the analogue part of the IC. In addition that block already performs important functions of the protocol stack as far as the MAC layer, error correction, real time clock, wake-up management, interrupt requests, automatic production of acknowledge signals and further tasks. All functions of that block are initialised and controlled by way of the application software on an external microcontroller.

A brief description of the block circuit diagram of FIG. 14 is set out hereinafter.

Transmitter (TX):

An important situation of use for the NANONET transceiver is recording analogue sensor data, converting same into digital signals and transmitting those digital data to a receiver by way of an air interface. The Analogue Sensor Interface (1) serves for recording the sensor data in a plurality of channels, in addition that module provides a current source for supplying the connected sensors. The operation of reading out the connected sensors is started by the application software, the sensor data are subjected to A/D conversion by the Analogue Sensor Interface and transmitted to the block Control Registers (x) of the digital part. The sensor data can be transmitted to the application by way of the illustrated linesDiIO1, . . . DiO4.

The core part of the transmitter portion is the I/Q modulator (2). In dependence on the selected transmission mode the digital symbols to be transmitted are reproduced in the block Pulse Sequence (3) on to pre-stored bit sequences which represent the real part and the imaginary part of the transmission signal in the baseband. Those bit sequences are band-limited with the low pass filters (3) and (4) and passed to the inputs of the I/Q modulator (2). The carrier signal for the I/Q modulator is produced in the block Frequency Synthesization (5). That frequency synthesizer selectively produces the carrier for direct modulation at the transmitter side into the transmission frequency band or the carrier for down-mixing at the receiver end into the IF-position. The analogue switch (6) is controlled by the signal RX/TX and effects switching-over of the carrier between transmission and reception modes.

The output signal from the I/Q modulator (2) is passed to a pre-amplifier stage (7) and then to the Power Amplifier (8). The output power of the power amplifier can be controlled by the digital part by way of the block Power Control (9). The power amplifier can be switched off for the duration of the receiving period by way of the signal RX/TX.

Also shown in the block circuit diagram at the transmitter side is an internal oscillator OSC (10), provided for the connection of an external quartz, and Battery Management (11) for monitoring the charge condition of the battery.

Receiver (RX):

The reception signal of a connected antenna is coupled into the Low Noise Amplifier (LNA) (12). The LNA can be switched off for the duration of the transmission period with the signal RX/TX. Its gain is controlled by the block AGC (13). The LNA is followed by the Downmixer (14) which converts the received signal into the intermediate frequency position. The subsequently connected amplifier (15), like the LNA, is incorporated into the automatic gain control (AGC). Its output signal is coupled out of the transceiver.

The circuit is so provided that an SAW component can be externally directly connected to the IF amplifier (15), the SAW component comprising two dispersive delay lines with a complementary group transit time characteristic. The output signals of the two delay lines are coupled into the IC at the inputs of the amplifiers (16) and (17) which are regulated in multi-stage fashion.

For demodulation of those signals into the baseband, a respective detector stage (18) and (19) and subsequently connected low pass filter (20) and (21) are respectively connected to the input amplifiers (16) and (17) in the circuit.

The two low pass filters are each followed by a respective threshold value comparator (22) and (23) respectively. The threshold values for both comparators are adaptive and are determined in the block Threshold (24) from the LP-output signals themselves.

The comparator output signals are subjected to further processing in the digital part, there initially in the Bit Decoder.

For the demodulation of convolution pulses a multiplier (25) is available in the receiving part, with which multiplier the output signals of the dispersive filters are multiplied. The multiplier is followed by an amplifier stage (26) and two threshold value detectors (27) and (28) for the detection of the bipolar convolution signals. The threshold values for both comparators are adaptively determined within the block Threshold (24).

The output signals of the two comparators are subjected to further processing in the digital part.

The microcontroller interface (29) serves for transmission of the transmission and reception data and items of control information between the external microcontroller and the transceiver chip. It further synchronises the data communication between the two components.

The FIFO (30) buffers received data or data which are to be transmitted and effects decoupling in respect of time of the processes in the transceiver chip and the external microcontroller.

The MAC State Machine (31) controls analogue and digital blocks in accordance with the respective access method used (CSMA/CA, TDMA), it controls the implementation of the transmission and reception processes and it evaluates items of received protocol information (packet type, automatic target address comparison, ascertaining packet length and so forth).

The data which are to be transmitted or are received are processed in the digital bit processing unit (32) (frame synchronisation, check sum generation and control, forward error correction, scrambling/unscrambling, optionally encrypting/decrypting).

The symbols received by the analogue part are detected by the bit detector (33) and bit synchronisation is effected.

The power management (34) switches off external and internal power supplies (power saving mode) and switches them on again controlled by internal events (wake-up timer, battery management).

The microcontroller management (35) deactivates the power supply as well as all connections to the external microcontroller. After the power supply is switched on by the power management the start-up of the microcontroller is controlled here.

The real time clock (36) includes a real time clock which is used for controlling the access process (TDMA) and the power saving mode. It also serves for time detection for applications. The wake-up timer stores the moment in time for leaving the power saving mode for the power management.

The analogue blocks of the transceiver are controlled or interrogated by way of the control registers (37). The DiIOs (digital input/output) represent a digital sensor-actuator interface.

Hitherto suitable external SAW (Surface Acoustic Wave) components have usually been employed for receiving chirp signals. The present invention also makes it possible to implement chirp signal reception and detection thereof without corresponding external SAW components.

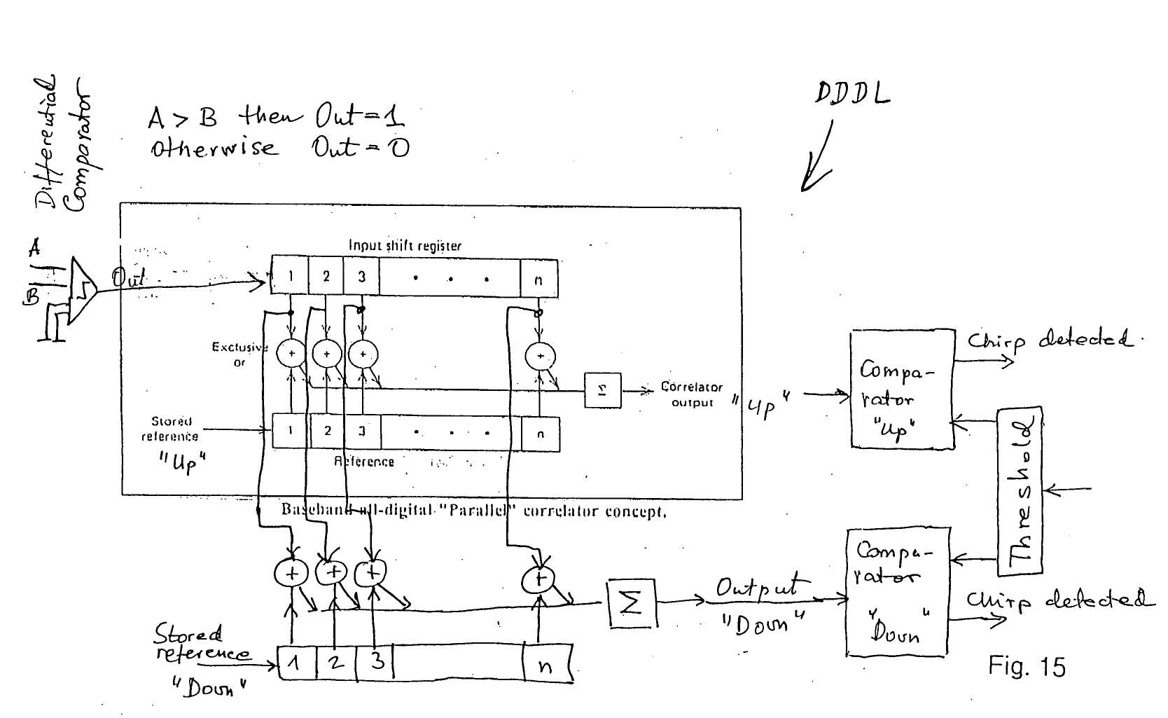

In that respect FIG. 15 shows that the chirp signal goes upon reception after passing through a differential comparator and the received signal is processed in a shift register connected to a suitable exclusive or interlaced reference shift register.

In that way an upchirp signal and also a downchirp signal can be clearly detected at the output side.

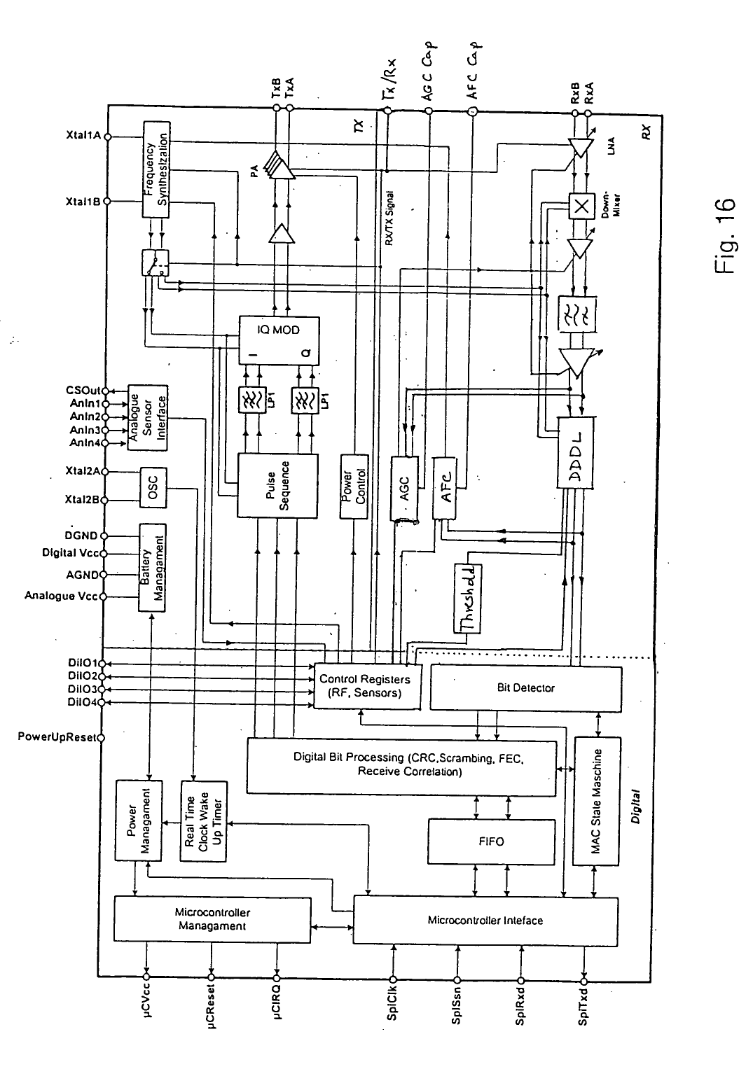

The use of the output correlator according to the invention means that it is possible to forego an external SAW component—FIG. 16—, which makes the receiver very advantageous and simple.

Insofar as the identification DDDL is used in the Figures, this is a ‘Digital Differential Dispersive Line’.

The invention is not restricted solely to the disclosed transceiver but chirp signal reception as is disclosed in FIGS. 15 and 16 can also be implemented independently of the transmitting unit of the transceiver.

The above-described transceiver can operate in the ISM band at about 2.4 GHz. In that case for each transmitted symbol a chirp pulse of a band width of 80 MHz is emitted (with an employed roll-off factor of 0.25, this results in an effective band width of 64 MHz). Accordingly the transceiver system is a true wide-band system with all required properties such as for example independence in relation to sources of noise.

In the receiver the energy which is distributed over the wide frequency range of 80 MHz is ‘collected in’ again so that the result is a very short and high pulse (sin x/x-function). For that purpose either an external SAW filter (surface acoustic wave) can be used in the receiver, or the solution as described with reference to FIGS. 15 and 16, so that only those energy parts which belong to the chirp pulse are ‘stacked one upon the other’, while all others (for example noise and interference signals) pass the filter. As a result the actual signal stands out clearly from the background. That ‘system gain’ can be freely selected within wide limits by increasing or reducing the length of the chirp pulse. In the above-described process a chirp pulse duration of 1 μsec and an effective band width of 64 MHz (at 18 dB) are sufficient.

With the above-described process and the corresponding transceiver, even at relatively high frequencies of 1.4 GHz, a range of 700 m in the open and more than 50 m in buildings (in each case with a transmission power of 10 mW, the upper limit in the ISM band), is possible. The available channel resource is almost 100% utilised.

At the same time the system requires extremely little current, about 5 mA in initial operation and 33 mA when transmitting 10 mW. The reason for this is substantially analogue signal processing which manages entirely without expensive digital signal processors for echo suppression.

Even less however is a low level of power consumption in the rest times of the network (sleep mode) as generally data are transmitted only highly sporadically. Here the system with a current of less than one μA is already at the limit of what is physically possible. That also makes it possible to achieve battery operating times of several years (the battery can be disposed in the transceiver).

The described transceiver chip can be embodied using silicon-germanium technology, but also using CMOS technology.

The particular application options of the described transceiver involve factory automation, for example for monitoring machines. In addition a good field of application is intelligent access control with wireless keys (for example chip cards, active RFID), in order to wirelessly identify people, animals or goods. In comparison with passive systems the active RFID logistic tags have a greater range and in addition can also be re-programmed. The use for alarm systems is also highly suitable, in particular including alarm systems for fire or movement, and in that respect a bidirectional communication is possible between a transceiver and a corresponding chirp sensor. Use is also possible for networking computers, for example networking between a personal computer and a PDA or between a personal computer and the peripherals (mouse, keyboard).

As shown in FIG. 15 the DDDL comprises an input shift register which receives the output signal of a differential comparator. Each cell of the input shift register is linked to an exclusive OR unit which is further connected to the output of a memory which contains a stored reference for an upchirp signal and/or a stored sequence of a downchirp signal. The individual results of the plurality of exclusive OR units are summed and made available to the correlator output. The sum result is processed in a comparator component for ‘UP’ or ‘DOWN’ and then the corresponding chirp signal is detected at the output of the comparator and the result is made available. Besides the output of the correlator output signal the comparator also receives a threshold signal and delivers at the output a chirp-detected signal if the comparison result between the correlator output signal and the threshold signal can be correspondingly detected.

1. A transceiver of a transmission system having a device for producing a chirp signal, wherein there is provided a memory (RAM, ROM) in which is stored a plurality of different chirp sequences which respectively correspond individually or in pairs to a predetermined chirp signal, wherein upon call a desired individual chirp sequence or a pair of chirp sequences is read out of the memory and a predetermined chirp signal is produced by means of the producing device which preferably singly or in pairs has the combination of a digital/analogue converter and a low pass member.

2. A transceiver as set forth in claim 1 wherein, the chirp sequences stored in the memory can be sampled and bit-quantized chirp signals in the baseband, in the original frequency position or in the IF position, wherein bit quantization can be freely selected in the range of 1 . . . n.

3. A transceiver as set forth in claim 2 wherein, the chirp signal (which can be any one) can be produced without a corresponding chirp filter, wherein outputted at the output of the producing device are two signals I and Q which correspond to the real part and the imaginary part of the predetermined chirp signal in the baseband.

4. A transceiver as set forth in claim 2 wherein outputted at the output of the producing device is a signal which corresponds to the predetermined chirp signal in the transmission frequency position.

5. A transceiver as set forth in claim 2 wherein outputted at the output of the producing device is a signal which corresponds to the predetermined chirp signal in the intermediate frequency position.

6. A transceiver as set forth in claim 2 wherein, for data transmission convolution pulses, that is to say combination signals comprise upchirp pulses and downchirp pulses, are used, this involving purely real signals so that only one single chirp sequence has to be stored in the memory for the representation thereof in the baseband.

7. A transceiver as set forth in claim 3 wherein the output signals I and Q of the producing device are converted into the transmission frequency band by means of an I/Q modulator.

8. A transceiver as set forth in claim 5 wherein the output signal of the producing device is converted from the IF position into the transmission band by means of a modulation device (for example a mixer, a modulator or a simple multiplier).

9. A transceiver as set forth in claim 6 wherein the convolution pulse baseband signal at the output of the producing device is impressed on a real carrier signal by means of a single modulation member (for example a mixer, a modulator or a simple multiplier) and thereby converted into the transmission frequency band.

10. A transceiver as set forth in claim 1 wherein chirp signals of a differing BT-product and/or a differing time-frequency characteristic are stored in the memory and can be called up therefrom.

11. A transceiver as set forth in claim 10 wherein it is possible to have recourse to different ones of the stored chirp sequences in dependence on the transmission requirements.

12. A transceiver as set forth in claim 10 wherein switching-over to other chirp sequences can take place during ongoing transmission.

13. A transceiver as set forth in claim 1 wherein the required chirp sequences in a process of starting up operation or initialisation are transferred into the memory of the transceiver by download and if required can also be replaced by re-programming.

14. A transceiver as set forth in claim 2 wherein the sampled chirp signals are additionally weighted with selectable filter functions (for example with a cosine roll-off characteristic) prior to quantization and storage in the memory.

15. A transceiver as set forth in claim 1 wherein the chirp signals which come in at the receiver end are compressed with suitable dispersive filters in the carrier frequency band and are then directly and asynchronously demodulated into the baseband.

16. A transceiver as set forth in claim 1 wherein the chirp signals coming in at the receiver end are firstly converted into the intermediate frequency position, then compressed with suitable dispersive filters into the IF position and then asynchronously demodulated into the baseband.

17. A transceiver as set forth in claim 1 wherein the receiver device can be tuned(=programmed) to the chirp signal used at the transmitter end by simple exchange of the dispersive filters used while retaining all other receiver components.

18. A transceiver, in particular as set forth in claim 1, for producing, emitting and receiving convolution signals, wherein the convolution signals are compressed at the receiver end in the carrier frequency position by means of complementary dispersive delay lines and demodulated directly and asynchronously into the baseband by multiplication of the output signals of both delay lines.

19. A transceiver as set forth in claim 1, for producing, emitting and receiving convolution signals, wherein the convolution signals are firstly converted at the receiver end into the intermediate frequency position, compressed by means of complementary dispersive delay lines and demodulated asynchronously into the baseband by multiplication of the output signals of both delay lines.

20. A transceiver as set forth in claim 19 wherein the congruence in respect of time of the envelope curves of the two compressed signals is used as a criterion for coincidence of the IF center frequency and the center frequency of the complementary dispersive filters in order to tune the local oscillator of the receiving device in a phase regulating circuit.

21. A transceiver as set forth in claim 19 wherein the output signals of the complementary dispersive delay lines are firstly passed to an envelope curve detector with subsequent threshold value comparator and the output signals of the threshold value comparators are passed to a phase detector whose output signal reflects the displacement in respect of time of the two envelope curves in respect of amount and polarity.

22. A transceiver as set forth in claim 21 wherein the output signal of the phase detector is passed to a regulator which changes the setting voltage of a voltage-controlled oscillator (VCO) for producing the local oscillator (LO) at the receiver end, until both envelope curves are congruent.

23. A transceiver as set forth in claim 1 wherein the received signal is synchronised to the center frequency of the complementary dispersive group transit time filters.

24. A transceiver as set forth in claim 1 wherein the phase regulating circuit also regulates out changes in the center frequency of the dispersive filters, which were produced by a rise in temperature, ageing or other influences.

25. A transceiver as set forth in claim 1 for burst-wise transmission of data sequences by means of convolution pulses, wherein a data sequence to be transmitted is preceded by a preamble comprising convolution pulses, which serves specifically for bringing frequency regulation into effect.

26. A transceiver as set forth in claim 25 wherein upon the attainment of the steady-state condition of frequency regulation the VCO setting voltage is sampled with a sample-and-hold member and is held fast for the duration of a data burst.

27. A transceiver as set forth in claim 1 for burst-wise transmission of upchirp/downchirp pulses, wherein a data sequence to be transmitted is preceded by a preamble comprising convolution pulses, which serves specifically for bringing frequency regulation into effect and upon the attainment of the steady-state condition of frequency regulation the VCO setting voltage is sampled with a sample-and-hold member and is held fast for the duration of a data burst.

28. A transceiver as set forth in claim 1 for automatic frequency regulation in a system for burst-wise transmission of upchirp/downchirp pulses, wherein a data sequence is preceded in a preamble by a series of mutually alternate upchirp and downchirp pulses and the phase regulating circuit as shown in FIG. 3 regulates not to a condition of congruence of the envelope curves but to a phase displacement of 180° and upon the attainment of the steady-state condition of frequency regulation the VCO setting voltage is sampled with a sample-and-hold member and is held fast for the duration of a data burst.

29. A transceiver as set forth in claim 28 wherein the phase detector is adapted to be switched over for receiving convolution pulses or upchirp/downchirp pulses.

30. A transceiver as set forth in claim 1 with frequency regulation for receiving upchirp/downchirp pulses, wherein an uninterrupted sequence of symbols which is the same as the detected symbols of a convolution pulse sequence is produced in both branches which adjoin the dispersive filters by the insertion of dummy symbols so that a subsequent phase detector can effect checking in respect of congruence of the envelope curves and the regulating circuit shown in FIG. 4 can also be used for frequency regulation of an upchirp/downchirp system.

31. A transceiver as set forth in claim 30 wherein the symbol sequences produced at the transmitter end are suitably scrambled prior to transmission, with the aim that the number of successive symbols of the same polarity does not exceed a specified value.

32. A transceiver as set forth in claim 1 wherein the chirp signals which are received in the receiver are firstly converted into the IF position, compressed in complementary dispersive delay lines, then demodulated into the baseband with envelope curve detectors and converted with threshold value comparators into digitally processible signals and a logic EXCLUSIVE OR gate is used for deriving the symbol clock, said gate linking the output signals of the threshold value detectors, while a JK flip-flop is used for representation of the current datum, the inputs J and K thereof being connected to the outputs of the threshold value detectors and the clock input thereof being actuated with the output signal of the EXCLUSIVE OR gate.

33. A transceiver as set forth in claim 1 for receiving convolution pulses, wherein the chirp signals which are received in the receiver are firstly converted into the IF position and compressed in complementary dispersive delay lines and the output signals of the delay lines are multiplied together and the output signal of the multiplier is subjected to full-wave rectification and then passed to a threshold value comparator, at the output of which there is the symbol clock.

34. A transceiver as set forth in claim 1 for receiving convolution pulses, wherein the chirp signals received in the receiver are firstly converted into the IF position and compressed in complementary dispersive delay lines, then demodulated into the baseband with envelope curve detectors and converted into digitally processible signals with threshold value comparators, and the outputs of the threshold value comparators are subjected to logical AND gating in order to derive the symbol clock.

35. A transceiver, in particular as set forth in claim 1 for receiving convolution pulses, wherein the chirp signals received in the receiver are firstly converted into the IF position and compressed in complementary dispersive delay lines, and the output signals of the delay lines are multiplied together and the bipolar output signals of the multiplier are converted into digitally processible signals with subsequent threshold value comparators, whereupon the output signals of the threshold value comparators are subjected to logical AND gating in order to derive the symbol clock, while a JK flip-flop is used to represent the current datum, the inputs J and K of which are connected to the outputs of the threshold value detectors and the clock input of which is actuated with the output signal of the OR gate.

36. A transceiver with clock derivation as set forth in claim 32 having a gating device comprising a switch and a time control which operates in such a way that a symbol clock pulse entering at the input end is recognised by the time control and causes opening of the switch for the duration of a specified blocking interval which is shorter than a symbol clock period, whereby interference pulses which occur within the symbol interval are suppressed while the next following symbol clock pulse can again pass and can again trigger off the procedure.

37. A transceiver as set forth in claim 36 wherein a logic AND gate performs the function of the switch and a monoflop determines the length of the blocking interval.

38. A transceiver as set forth in claim 36 wherein the length of the blocking interval is variable and can be matched to the transmission situation, for example to interference phenomena on transmission.

39. A transceiver as set forth in claim 38 wherein a short blocking interval is used for the phase of bringing the receiving system into operation while the arrangement switches over to a longer blocking interval in the steady-state condition.

40. A transceiver as set forth in claim 36 wherein the gate, triggered by a symbol clock pulse, closes for the duration of a blocking interval, then opens for the duration of an opening interval (within which the next symbol clock pulse is expected) and then closes again for the duration of a blocking interval, and that process is continuously repeated.

41. A transceiver, in particular as set forth in claim 1, wherein the chirp signals received in the receiver are firstly converted into the IF position, compressed in complementary dispersive delay lines, and then the compressed signals are passed in both branches to a respective envelope curve detector, an average value detector and a peak value detector, wherein in downstream-connected threshold value comparators the output signal of the respective envelope curve detector is compared to a threshold value which can variably assume a value between the average value and the peak value of the detected signal.

42. A transceiver as set forth in claim 41 wherein in both branches the position of the threshold value can be digitally controlled between the signal average value and the signal peak value.

43. A transceiver as set forth in claim 42 wherein in both branches a voltage is added to the threshold value formed from the signal average value and the signal peak value, thereby providing that the threshold value at the comparator input is always higher than the noise amplitude at the output of the envelope curve detector.
